(19) United States
(12) Patent Application Publication
(10) Pub. No.: US 2023/0071488 A1
(43) Pub. Date: Mar. 9, 2023

(54) ROBOTIC SYSTEM WITH OVERLAP PROCESSING MECHANISM AND METHODS FOR OPERATING THE SAME

(71) Applicant: MUJIN, Inc., Tokyo (JP)

(72) Inventors: Yoshiki Kanemoto, Tokyo (JP); Ahmed Abouelela, Tokyo (JP); Jinze Yu, Tokyo (JP); Jose Jeronimo Moreira Rodrigues, Tokyo (JP); Rosen Nikolaev Diankov, Tokyo (JP)

(21) Appl. No.: 17/901,739

(22) Filed: Sep. 1, 2022

Related U.S. Application Data
(60) Provisional application No. 63/239,795, filed on Sep. 1, 2021.

(51) Int. Cl. B25J 9/16

(52) U.S. Cl. CPC B25J 9/1697

(57) ABSTRACT

A system and method for processing overlapped flexible objects is disclosed.

### RELATED APPLICATIONS

This application claims the benefit of U.S. Provisional Patent Application Ser. No. 63/239,795, filed Sep. 1, 2021, which is incorporated herein by reference in its entirety.

### TECHNICAL FIELD

The present technology is directed generally to robotic systems and, more specifically, robotic systems with object update mechanisms.

### BACKGROUND

Robots (e.g., machines configured to automatically/autonomously execute physical actions) are now extensively used in many fields. Robots, for example, can be used to execute various tasks (e.g., manipulate or transfer an object) in manufacturing, packaging, transport and/or shipping, etc. In executing the tasks, robots can replicate some human actions, thereby replacing or reducing human involvements that are otherwise required to perform dangerous or repetitive tasks. However, robots often lack the sophistication necessary to duplicate the human sensitivity and/or adaptability required for executing more complex tasks. For example, robots often have difficulty recognizing or processing subtleties and/or unexpected conditions. Accordingly, there remains a need for improved robotic systems and techniques for controlling and managing various aspects of the robots to handle subtleties and unexpected conditions.

### BRIEF DESCRIPTION OF THE DRAWINGS

FIG. 1 illustrates an example environment in which a robotic system transports objects in accordance with one or more embodiments of the present technology.

FIG. 2 is a block diagram illustrating the robotic system in accordance with one or more embodiments of the present technology.

FIG. 3 illustrates a robotic transfer configuration in accordance with one or more embodiments of the present technology.

FIGS. 4A and 4B illustrate example views of objects at a start location in accordance with one or more embodiments of the present technology.

FIG. 5 is flow diagram for operating a robotic system in accordance with one or more embodiments of the present technology.

### DETAILED DESCRIPTION

Systems and methods for transferring objects using robotic systems are described herein. The objects can include, in particular, flexible (e.g., non-rigid) objects. Further, the processed objects can include unexpected objects that, based on image processing results, fail to fully match one or more aspects of registered objects (e.g., as described in master data). Processing locations, shapes, sizes, and arrangements of flexible objects in a stack using image data can be challenging as the surfaces of the flexible objects can be distorted by shapes, contours, and/or edges of the underlying supporting objects. Embodiments of the present technology can process received image data depicting objects at a start location to identify or estimate overlapped regions of objects. A robotic system can process the two- and/or three-dimensional image data to essentially distinguish between peripheral edges, overlapped edges, imprinted surface features, or the like for gripping and picking up the flexible objects from the stack. The processing can include categorizing portions of the image data as fully detected areas, occlusion mask areas (e.g., including contested portions over the overlapped regions), or detection mask areas (e.g., including regions utilized for object detection as representations of surfaces of top-most objects or exposed portions of objects) to assist in identifying grip locations and a sequence of gripping objects from a stack. The robotic system can determine grip locations for grasping and transferring the objects based on the categorized portions. In some embodiments, the robotic system can use the processed image data to derive and implement a motion plan for moving the grasped object laterally before lifting. Such a motion plan may be derived based on one or more characteristics of the occlusion mask(s) and/or the detection masks.

As an illustrative example, the robotic system (via, e.g., a controller) can be configured to control and operate a robotic arm assembly (e.g., a picker robot) for implementing transfer tasks. The transfer tasks can correspond to picking relatively soft/flexible objects, relatively thin objects and/or relatively transparent objects. Examples of such objects can include sack-covered objects, cloth-based objects wrapped in plastic sheet or bag and/or transparent containers, sheets, or sheets. When laid on top of each other, such target objects may cause deformations (e.g., lines) or other visual artifacts to appear on or through the surface of the overlaid object due to imprinting of a bottom/overlapped object. Embodiments of the technology described below can process such imprints and deformations depicted in the corresponding images (e.g., top view images of the overlaid or stacked objects) for recognition. In other words, the robotic system can process the images to effectively distinguish between the surface deformations and/or any visual features/images on the object surfaces from actual edges (e.g., peripheral edges) of the objects. Based on the processing, the robotic system can derive and implement motion plans that transfer the objects while accounting for and adjusting for the overlaps.

In the following, numerous specific details are set forth to provide a thorough understanding of the presently disclosed technology. In other embodiments, the techniques introduced here can be practiced without these specific details. In other instances, well-known features, such as specific functions or routines, are not described in detail in order to avoid unnecessarily obscuring the present disclosure. References in this description to “an embodiment,” “one embodiment,” or the like mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics can be combined in any suitable manner in one or more embodiments. It is to be understood that the various embodiments shown in the figures are merely illustrative representations and are not necessarily drawn to scale.

Several details describing structures or processes that are well-known and often associated with robotic systems and subsystems, but that can unnecessarily obscure some significant aspects of the disclosed techniques, are not set forth in the following description for purposes of clarity. Moreover, although the following disclosure sets forth several embodiments of different aspects of the present technology, several other embodiments can have different configurations or different components than those described in this section. Accordingly, the disclosed techniques can have other embodiments with additional elements or without several of the elements described below.

Many embodiments or aspects of the present disclosure described below can take the form of computer- or controller-executable instructions, including routines executed by a programmable computer or controller. Those skilled in the relevant art will appreciate that the disclosed techniques can be practiced on computer or controller systems other than those shown and described below. The techniques described herein can be embodied in a special-purpose computer or data processor that is specifically programmed, configured, or constructed to execute one or more of the computer-executable instructions described below. Accordingly, the terms “computer” and “controller” as generally used herein refer to any data processor and can include Internet appliances and handheld devices (including palm-top computers, wearable computers, cellular or mobile phones, multi-processor systems, processor-based or programmable consumer electronics, network computers, mini computers, or the like). Information handled by these computers and controllers can be presented at any suitable display medium, including a liquid crystal display (LCD). Instructions for executing computer- or controller-executable tasks can be stored in or on any suitable computer-readable medium, including hardware, firmware, or a combination of hardware and firmware. Instructions can be contained in any suitable memory device, including, for example, a flash drive, USB device, and/or other suitable medium, including a tangible, non-transient computer-readable medium.

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements co-operate or interact with each other (e.g., as in a cause-and-effect relationship, such as for signal transmission/reception or for function calls), or both.

### Suitable Environments

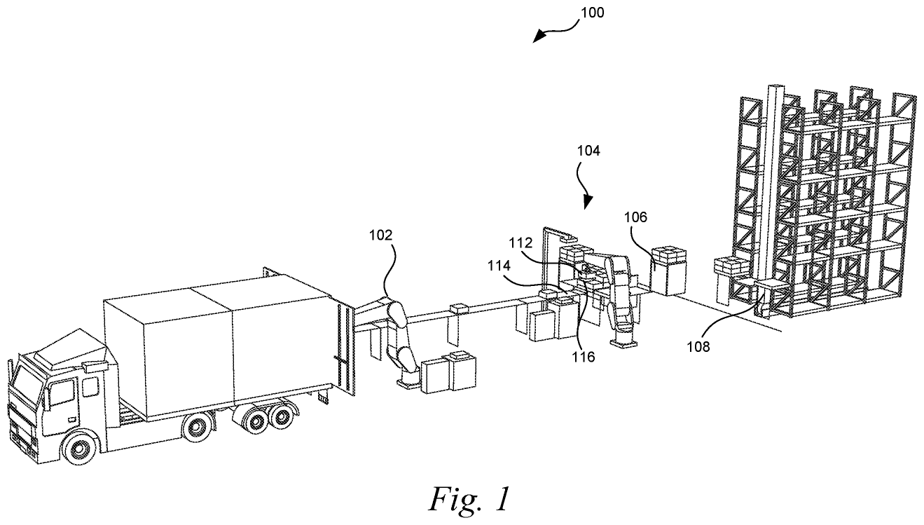

FIG. 1 is an illustration of an example environment in which a robotic system 100 transports objects in accordance with one or more embodiments of the present technology. The robotic system 100 can include and/or communicate with one or more units (e.g., robots) configured to execute one or more tasks. Aspects of the object detection/update can be practiced or implemented by the various units.

For the example illustrated in FIG. 1, the robotic system 100 can include and/or communicate with an unloading unit 102, a transfer unit 104 (e.g., a palletizing robot and/or a piece-picker robot), a transport unit 106, a loading unit 108, or a combination thereof in a warehouse or a distribution/shipping hub. Each of the units in the robotic system 100 can be configured to execute one or more tasks. The tasks can be combined in sequence to perform an operation that achieves a goal, such as to unload objects from a truck or a van and store them in a warehouse or to unload objects from storage locations and prepare them for shipping. For another example, the task can include placing the objects on a target location (e.g., on top of a pallet and/or inside a bin/cage/box/case). As described below, the robotic system can detect the objects and derive plans (e.g., placement locations/orientations, sequence for transferring the objects, and/or corresponding motion plans) for picking, placing, and/or stacking the objects. Each of the units can be configured to execute a sequence of actions (e.g., by operating one or more components therein) according to one or more of the derived plans to execute a task.

In some embodiments, the task can include manipulation (e.g., moving and/or reorienting) of a target object 112 (e.g., one of the packages, boxes, cases, cages, pallets, etc., corresponding to the executing task), such as to move the target object 112 from a start location 114 to a task location 116. For example, the unloading unit 102 (e.g., a devanning robot) can be configured to transfer the target object 112 from a location in a carrier (e.g., a truck) to a location on a conveyor belt. Also, the transfer unit 104 can be configured to transfer the target object 112 from one location (e.g., the conveyor belt, a pallet, a container, a box, or a bin) to another location (e.g., a pallet, a container, a box, a bin, etc.). For another example, the transfer unit 104 (e.g., a picker robot) can be configured to transfer the target object 112 from a source location (e.g., a container, a cart, a pickup area, and/or a conveyor) to a destination. In completing the operation, the transport unit 106 can transfer the target object 112 from an area associated with the transfer unit 104 to an area associated with the loading unit 108, and the loading unit 108 can transfer the target object 112 (e.g., by moving the pallet, the container, and/or the rack carrying the target object 112) from the transfer unit 104 to a storage location (e.g., a location on the shelves).

For illustrative purposes, the robotic system 100 is described in the context of a shipping center; however, it is understood that the robotic system 100 can be configured to execute tasks in other environments/for other purposes, such as for manufacturing, assembly, packaging, healthcare, and/or other types of automation. It is also understood that the robotic system 100 can include and/or communicate with other units, such as manipulators, service robots, modular robots, etc., not shown in FIG. 1. For example, in some embodiments, other units can include a palletizing unit for placing objects onto a pallet, a depalletizing unit for transferring the objects from cage carts or pallets onto conveyors or other pallets, a container-switching unit for transferring the objects from one container to another, a packaging unit for wrapping the objects, a sorting unit for grouping objects according to one or more characteristics thereof, a piece-picking unit for manipulating (e.g., for sorting, grouping, and/or transferring) the objects differently according to one or more characteristics thereof, or a combination thereof.

The robotic system 100 can include and/or be coupled to physical or structural members (e.g., robotic manipulator arms) that are connected at joints for motion (e.g., rotational and/or translational displacements). The structural members and the joints can form a kinetic chain configured to manipulate an end-effector (e.g., the gripper) configured to execute one or more tasks (e.g., gripping, spinning, welding, etc.) depending on the use/operation of the robotic system 100. The robotic system 100 can include and/or communicate with the actuation devices (e.g., motors, actuators, wires, artificial muscles, electroactive polymers, etc.) configured to drive or manipulate (e.g., displace and/or reorient) the structural members about or at a corresponding joint. In some embodiments, the robotic units can include transport motors configured to transport the corresponding units/chassis from place to place.

The robotic system 100 can include and/or communicate with sensors configured to obtain information used to implement the tasks, such as for manipulating the structural members and/or for transporting the robotic units. The sensors can include devices configured to detect or measure one or more physical properties of the robotic system 100 (e.g., a state, a condition, and/or a location of one or more structural members/joints thereof) and/or of a surrounding environment. Some examples of the sensors can include accelerometers, gyroscopes, force sensors, strain gauges, tactile sensors, torque sensors, position encoders, etc.

In some embodiments, for example, the sensors can include one or more imaging devices (e.g., visual and/or infrared cameras, 2D and/or 3D imaging cameras, distance measuring devices such as lidars or radars, etc.) configured to detect the surrounding environment. The imaging devices can generate representations of the detected environment, such as digital images and/or point clouds, that may be processed via machine/computer vision (e.g., for automatic inspection, robot guidance, or other robotic applications). The robotic system 100 can process the digital image and/or the point cloud to identify the target object 112 and/or a pose thereof, the start location 114, the task location 116, or a combination thereof.

For manipulating the target object 112, the robotic system 100 can capture and analyze an image of a designated area (e.g., a pickup location, such as inside the truck or on the conveyor belt) to identify the target object 112 and the start location 114 thereof. Similarly, the robotic system 100 can capture and analyze an image of another designated area (e.g., a drop location for placing objects on the conveyor, a location for placing objects inside the container, or a location on the pallet for stacking purposes) to identify the task location 116. For example, the imaging devices can include one or more cameras configured to generate images of the pickup area and/or one or more cameras configured to generate images of the task area (e.g., drop area). Based on the captured images, as described below, the robotic system 100 can determine the start location 114, the task location 116, the object detection results including the associated poses, the packing/placement plan, the transfer/packing sequence, and/or other processing results.

In some embodiments, for example, the sensors can include position sensors (e.g., position encoders, potentiometers, etc.) configured to detect positions of structural members (e.g., the robotic arms and/or the end-effectors) and/or corresponding joints of the robotic system 100. The robotic system 100 can use the position sensors to track locations and/or orientations of the structural members and/or the joints during execution of the task.

### Robotic Systems

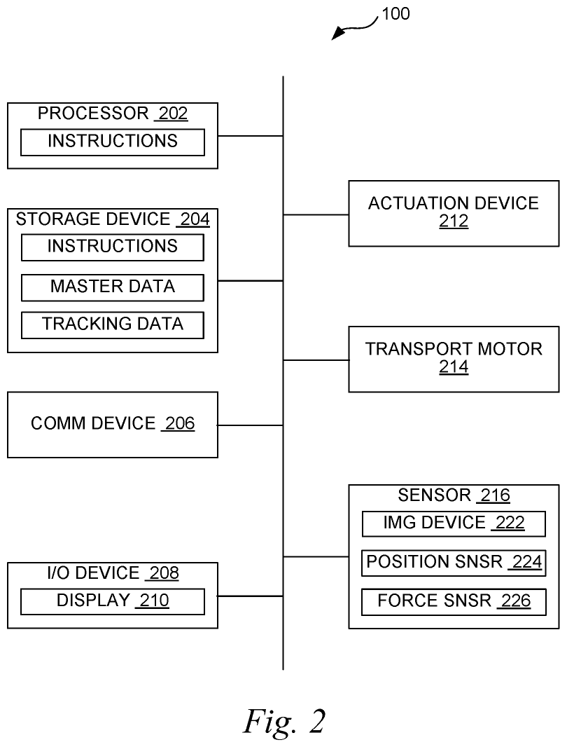

FIG. 2 is a block diagram illustrating components of the robotic system 100 in accordance with one or more embodiments of the present technology. In some embodiments, for example, the robotic system 100 (e.g., at one or more of the units or assemblies and/or robots described above) can include electronic/electrical devices, such as one or more processors 202, one or more storage devices 204, one or more communication devices 206, one or more input-output devices 208, one or more actuation devices 212, one or more transport motors 214, one or more sensors 216, or a combination thereof. The various devices can be coupled to each other via wire connections and/or wireless connections. For example, one or more units/components for the robotic system 100 and/or one or more of the robotic units can include a bus, such as a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus (also referred to as “Firewire”). Also, for example, the robotic system 100 can include and/or communicate with bridges, adapters, controllers, or other signal-related devices for providing the wire connections between the devices. The wireless connections can be based on, for example, cellular communication protocols (e.g., 3G, 4G, LTE, 5G, etc.), wireless local area network (LAN) protocols (e.g., wireless fidelity (WIFI)), peer-to-peer or device-to-device communication protocols (e.g., Bluetooth, Near-Field communication (NFC), etc.), Internet of Things (IoT) protocols (e.g., NB-IoT, Zigbee, Z-wave, LTE-M, etc.), and/or other wireless communication protocols.

The processors 202 can include data processors (e.g., central processing units (CPUs), special-purpose computers, and/or onboard servers) configured to execute instructions (e.g., software instructions) stored on the storage devices 204 (e.g., computer memory). The processors 202 can implement the program instructions to control/interface with other devices, thereby causing the robotic system 100 to execute actions, tasks, and/or operations.

The storage devices 204 can include non-transitory computer-readable mediums having stored thereon program instructions (e.g., software). Some examples of the storage devices 204 can include volatile memory (e.g., cache and/or random-access memory (RAM) and/or non-volatile memory (e.g., flash memory and/or magnetic disk drives). Other examples of the storage devices 204 can include portable memory drives and/or cloud storage devices.

In some embodiments, the storage devices 204 can be used to further store and provide access to master data, processing results, and/or predetermined data/thresholds. For example, the storage devices 204 can store master data that includes descriptions of objects (e.g., boxes, cases, containers, and/or products) that may be manipulated by the robotic system 100. In one or more embodiments, the master data can include a dimension, a shape (e.g., templates for potential poses and/or computer-generated models for recognizing the object in different poses), a color scheme, an image, an identification information (e.g., bar codes, quick response (QR) codes, logos, etc., and/or expected locations thereof), an expected mass or weight, or a combination thereof for the objects expected to be manipulated by the robotic system 100. In some embodiments, the master data can include information about surface patterns (e.g., printed images and/or visual aspects of corresponding material), surface roughness, or any features associated with surfaces of the objects. In some embodiments, the master data can include manipulation-related information regarding the objects, such as a center-of-mass location on each of the objects, expected sensor measurements (e.g., force, torque, pressure, and/or contact measurements) corresponding to one or more actions/maneuvers, or a combination thereof. The robotic system can look up pressure levels (e.g., vacuum levels, suction levels, etc.), gripping/pickup areas (e.g., areas or banks of vacuum grippers to be activated), and other stored master data for controlling transfer robots.

The storage devices 204 can also store object tracking data. The tracking data includes registration data that indicates objects that are registered in the master data. The registration data can include information of objects that are expected to be stored at a start location and/or are expected to be moved at a drop location. In some embodiments, the object tracking data can include a log of scanned or manipulated objects. In some embodiments, the object tracking data can include image data (e.g., a picture, point cloud, live video feed, etc.) of the objects at one or more locations (e.g., designated pickup or drop locations and/or conveyor belts). In some embodiments, the object tracking data can include locations and/or orientations of the objects at the one or more locations.

The communication devices 206 can include circuits configured to communicate with external or remote devices via a network. For example, the communication devices 206 can include receivers, transmitters, modulators/demodulators (modems), signal detectors, signal encoders/decoders, connector ports, network cards, etc. The communication devices 206 can be configured to send, receive, and/or process electrical signals according to one or more communication protocols (e.g., the Internet Protocol (IP), wireless communication protocols, etc.). In some embodiments, the robotic system 100 can use the communication devices 206 to exchange information between units of the robotic system 100 and/or exchange information (e.g., for reporting, data gathering, analyzing, and/or troubleshooting purposes) with systems or devices external to the robotic system 100.

The input-output devices 208 can include user interface devices configured to communicate information to and/or receive information from human operators. For example, the input-output devices 208 can include a display 210 and/or other output devices (e.g., a speaker, a haptics circuit, or a tactile feedback device, etc.) for communicating information to the human operator. Also, the input-output devices 208 can include control or receiving devices, such as a keyboard, a mouse, a touchscreen, a microphone, a user interface (UI) sensor (e.g., a camera for receiving motion commands), a wearable input device, etc. In some embodiments, the robotic system 100 can use the input-output devices 208 to interact with the human operators in executing an action, a task, an operation, or a combination thereof.

In some embodiments, a controller can include the processors 202, storage devices 204, communication devices 206, and/or input-output devices 208. The controller can be a standalone component or part of a unit/assembly. For example, each unloading unit, a transfer assembly, a transport unit, and a loading unit of the robotic system 100 can include one or more controllers. In some embodiments, a single controller can control multiple units or standalone components.

The robotic system 100 can include and/or communicate with physical or structural members (e.g., robotic manipulator arms) connected at joints for motion (e.g., rotational and/or translational displacements). The structural members and the joints can form a kinetic chain configured to manipulate an end-effector (e.g., the gripper) configured to execute one or more tasks (e.g., gripping, spinning, welding, etc.) depending on the use/operation of the robotic system 100. The kinetic chain can include the actuation devices 212 (e.g., motors, actuators, wires, artificial muscles, electroactive polymers, etc.) configured to drive or manipulate (e.g., displace and/or reorient) the structural members about or at a corresponding joint. In some embodiments, the kinetic chain can include the transport motors 214 configured to transport the corresponding units/chassis from place to place. For example, the actuation devices 212 and transport motors connected to or part of a robotic arm, a linear slide, or other robotic component.

The sensors 216 can be configured to obtain information used to implement the tasks, such as for manipulating the structural members and/or for transporting the robotic units. The sensors 216 can include devices configured to detect or measure one or more physical properties of the controllers, the robotic units (e.g., a state, a condition, and/or a location of one or more structural members/joints thereof), and/or for a surrounding environment. Some examples of the sensors 216 can include contact sensors, proximity sensors, accelerometers, gyroscopes, force sensors, strain gauges, torque sensors, position encoders, pressure sensors, vacuum sensors, etc.

In some embodiments, for example, the sensors 216 can include one or more imaging devices 222 (e.g., 2-dimensional and/or 3-dimensional imaging devices). configured to detect the surrounding environment. The imaging devices can include cameras (including visual and/or infrared cameras), lidar devices, radar devices, and/or other distance-measuring or detecting devices. The imaging devices 222 can generate a representation of the detected environment, such as a digital image and/or a point cloud, used for implementing machine/computer vision (e.g., for automatic inspection, robot guidance, or other robotic applications).

Referring now to FIGS. 1 and 2, the robotic system 100 (via, e.g., the processors 202) can process image data and/or the point cloud to identify the target object 112 of FIG. 1, the start location 114 of FIG. 1, the task location 116 of FIG. 1, a pose of the target object 112 of FIG. 1, or a combination thereof. The robotic system 100 can use image data from the imaging device 222 to determine how to access and pick up objects. Images of the objects can be analyzed to detect the objects and determine a motion plan for positioning a vacuum gripper assembly to grip detected objects. The robotic system 100 (e.g., via the various units) can capture and analyze an image of a designated area (e.g., inside the truck, inside the container, or a pickup location for objects on the conveyor belt) to identify the target object 112 and the start location 114 thereof. Similarly, the robotic system 100 can capture and analyze an image of another designated area (e.g., a drop location for placing objects on the conveyor belt, a location for placing objects inside the container, or a location on the pallet for stacking purposes) to identify the task location 116.

Also, for example, the sensors 216 of FIG. 2 can include position sensors 224 of FIG. 2 (e.g., position encoders, potentiometers, etc.) configured to detect positions of structural members (e.g., the robotic arms and/or the end-effectors) and/or corresponding joints of the robotic system 100. The robotic system 100 can use the position sensors 224 to track locations and/or orientations of the structural members and/or the joints during execution of the task. The unloading unit, transfer unit, transport unit/assembly, and the loading unit disclosed herein can include the sensors 216.

In some embodiments, the sensors 216 can include one or more force sensors 226 (e.g., weight sensors, strain gauges, piezoresistive/piezoelectric sensors, capacitive sensors, elastoresistive sensors, and/or other tactile sensors) configured to measure a force applied to the kinetic chain, such as at the end-effector. For example, the sensor 216 can be used to determine a load (e.g., the grasped object) on the robotic arm. The force sensors 226 can be attached to or about the end-effector and configured such that the resulting measurements represent a weight of the grasped object and/or a torque vector relative to a reference location. In one or more embodiments, the robotic system 100 can process the torque vector, the weight, and/or other physical traits of the object (e.g., dimensions) to estimate the CoM of the grasped object.

### Robotic Transfer Configuration

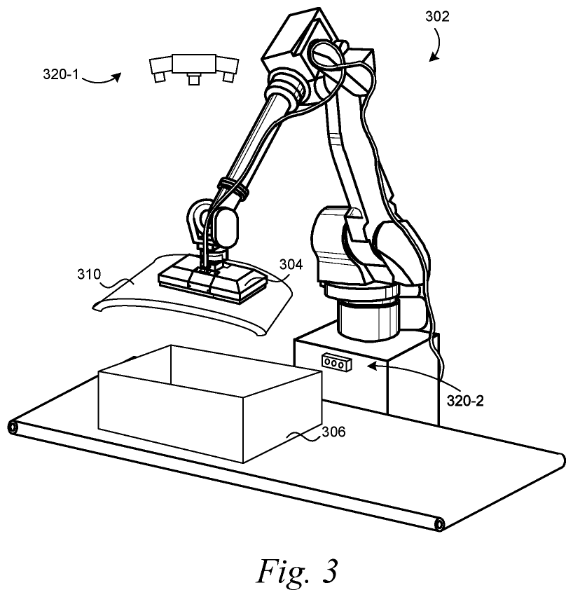

FIG. 3 illustrates a robotic transfer configuration in accordance with one or more embodiments of the present technology. The robotic transfer configuration can include a robotic arm assembly 302 having an end effector 304 (e.g., a gripper) configured to pick objects from a source container 306 (e.g., a bin having low and/or clear walls) and transfer them to a destination location. The robotic arm assembly 302 can have structural members and joints that function as a kinetic chain. The end effector 304 can include a vacuum-based gripper coupled to the distal end of the kinetic chain and configured draw in air and create a vacuum between a gripping interface (e.g., a bottom portion of the end effector 304) and a surface of the objects to grasp the objects.

In some embodiments, the robotic transfer configuration can be adapted to grasp and transfer flexible objects 310 (also referred to as deformable objects, e.g., objects having physical traits, such as thickness and/or rigidity, that satisfy a predetermined threshold) out of the source container 306. For example, the robotic transfer configuration can be adapted to use the vacuum-based gripper to grasp plastic pouches or clothes that may or may not be plastic-wrapped or bagged items from within the source container 306. In general, an object may be considered flexible when the object lacks structural rigidity such that an overhanging or ungripped portion (e.g., a portion extending beyond a footprint of the grasping end-effector) of an object bends, folds, or otherwise fails to maintain a constant shape/pose when the object is lifted/moved.

In gripping the flexible objects, the robotic system can obtain and process one or more images of the objects within the source container 306. The robotic system can obtain the images using imaging devices 320 (e.g., the imaging devices 320 including a downward facing imaging device 320-1 and/or a sideways facing imaging device 320-2 which are collectively called as imaging devices 320). The imaging devices 320 can be an implementation of the imaging devices 222 of FIG. 2. The imaging devices 320 can include 2-dimensional imaging devices and/or 3-dimensional depth measuring devices. For example, in FIG. 3, the downward facing imaging device 320-1 can be positioned to obtain top view images of the objects within the source container 306 and the sideways facing imaging device 320-2 is positioned to obtain side-view or perspective-view images of the objects and/or any corresponding containers (e.g., the source container 306) at the start location. As described in detail below, the robotic system 100 (via, e.g., the processor 202) can process the images from the imaging devices 320 to identify or estimate the edges of an object, derive a grippable region or area for a grip location for the object, derive a motion plan based on the grip location, implement the motion plan to transfer the object, or a combination thereof. Accordingly, the robotic system can grip and lift the targeted object from the start location (e.g., from inside of the source container 306), transfer the grasped object to a location over the target location (e.g., a destination, such as a bin, a delivery box, a pallet, a location on a conveyor, or the like), and lower/release the grasped object to place it at the target location.

### Image Processing

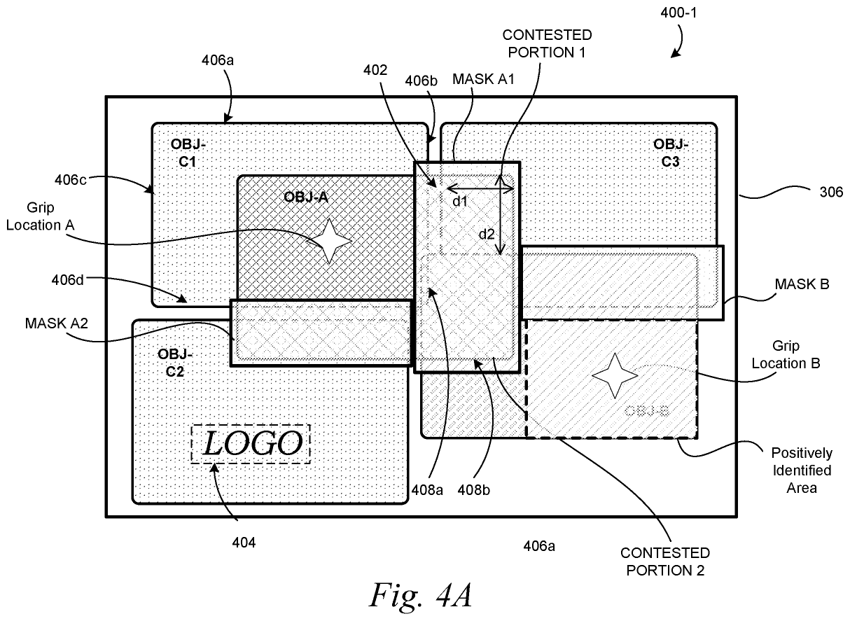

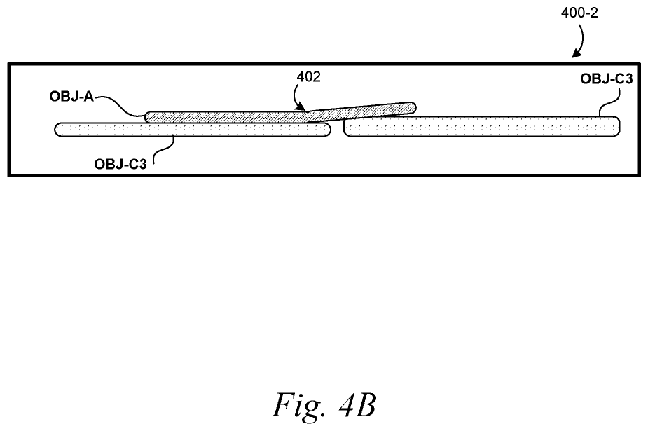

For describing the image processing, FIGS. 4A and 4B illustrate example views of objects at a start location in accordance with one or more embodiments of the present technology. FIG. 4A illustrates an example top view 400-1 of the objects at the start location. The top view 400-1 can correspond to one or more of 2-dimensional and/or 3-dimensional images from the downward facing imaging devices 320-1 in FIG. 3. The top view 400-1 can depict inner portions of the source container 306 and/or one or more objects (e.g., the flexible/deformable objects) therein. FIG. 4B illustrates an example side view 400-2 of the objects at the start location.

For the example illustrated in FIGS. 4A-4B, the source container 306 includes five flexible objects. Objects C1, C2, and C3 are located on (e.g., directly contacting and supported by) a bottom inner surface of the source container 306. An intermediate “object B” (e.g., upper portions thereof as illustrated in FIG. 4A) may partially overlap and be supported by objects C1 and C3. The remaining portion(s) of object B (e.g., lower portions) may directly contact the inner surface of the source container 306. A top “object A” may overlap and be supported by objects C1, C2, C3, and B.

One or more physical characteristics (e.g., thickness and/or the lack of rigidity) of the flexible objects and the shapes, contours, and/or edges of supporting objects may cause distortions in the surface of the overlapping object that is resting on top of the supporting objects. In other words, the physical shapes of the lower objects may cause deformations or distortions on the surfaces of the higher objects in the stack. Such deformation or distortions may be depicted in the obtained images. In FIG. 4A, the surface deformations caused by the underlying supporting objects are shown using different dashed lines. For example, a dashed line 402 in top view 400-1 of FIG. 4A can correspond to an imprint, bulge, or crease in object A as it is positioned on top of objects C1 and C3, as illustrated in the side view 400-2 in FIG. 4B. The imprint, bulge, or crease can be formed because object C3 has a top surface that is higher than the top surface of object C1 causing object A to bend. The obtained images can also depict any 2-dimensional printed surface features such as pictures or text printed on a surface of an object (e.g., logo 404).

In some embodiments, one or more of the objects in FIGS. 4A-4B and/or portions thereof can be transparent or translucent (e.g., packages having clear plastic wrappings, envelops, or sacks). In such embodiments, the different dashed lines correspond to edges and/or surface prints of the underlying objects that are seen through the upper transparent or translucent object. The image processing described herein can be applied to transparent objects as well as flexible objects.

The imprints, bulges, creases, see-through lines, object thickness, and/or other physical features and visible artifacts can introduce complications in recognizing or detecting the objects depicted in the obtained images. As described in detail below, the robotic system can process the image data to essentially distinguish between peripheral edges, overlapped edges, imprinted or distorted surface features, or the like and/or work around the imprinted surface features for gripping and picking up the flexible objects from the stack.

As an example, in some embodiments, the flexible objects may be referred to as thin flexible objects that have an average thickness below a thickness threshold or edge portions with a tapered shape, where the center of the object is thicker than the edge portions of the thin flexible objects. For instance, the thickness threshold can, in some embodiments, be one centimeter or less and, in other embodiments, the thickness threshold can be one millimeter or less. To continue the example, when the thin flexible objects are stacked or piled on one another at random orientations with varying degrees of overlap, it may be difficult to determine which of the thin flexible objects or portions of the thin flexible objects are on top or above the other thing flexible objects in the stack. The robotic system can process the image data based on identifying contested portions (e.g., portions of the image processed as having probabilities of being associated with or belonging to one of multiple objects), generating one or more types of masks and analyzing the different types of portions to determine the grippable regions or areas for the grip locations.

### Control Flow

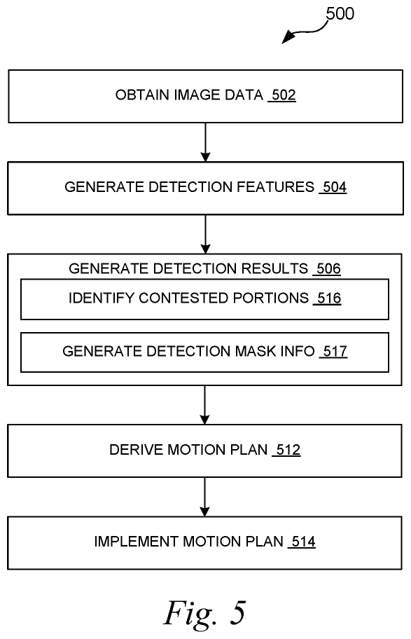

To describe the image processing, FIG. 5 is flow diagram of an example method 500 for operating a robotic system in accordance with one or more embodiments of the present technology. The method 500 can be implemented by the robotic system 100 of FIG. 1 (via, e.g., the controller and/or the processor 202 of FIG. 2) to process the obtained images and plan/perform tasks involving flexible objects. The method 500 is described below using the example illustrated in FIGS. 4A and 4B.

At block 502, the robotic system can obtain image data representative of the start location. The robotic system can obtain two-dimensional and/or three-dimensional (e.g., including depth measures) images from imaging devices, such as the top view 400-1 of FIG. 4A and the side view 400-2 of FIG. 4B from the imaging devices 320-1 and 320-2, respectively, of FIG. 3. The obtained image data can depict one or more objects (e.g., objects A, B, C1-C3 in FIGS. 4A-4B), such as the flexible objects 310 of FIG. 3 in the source container 306 of FIG. 3, located at the start location.

At block 504, the robotic system can generate detection features from the image data. The detection features can be elements of the image data that are processed and used for generating a detection hypothesis/result (e.g., an estimate of one or more object identities, corresponding poses/locations, and/or relative arrangements thereof associated with a portion of the image data) corresponding to the flexible objects depicted in the image data. The detection features can include edge features (e.g. lines in the image data that can correspond with the peripheral edges, or a portion thereof, of the flexible objects depicted in the image data) and key points that are generated from pixel in the 2D image data; and depth values and/or surface normal for three-dimensional (3D) points in the 3D point cloud image data. In an example for generating the edge features, the robotic system can detect lines depicted in the obtained image data using one or more circuits and/or algorithms (e.g., Sobel filters) to detect the lines. The detected lines can be further processed to determine to generate the edge features. As illustrated in FIG. 4A, the robotic system can process the detected lines to identify lines 406a-406d as the edge features that correspond to the peripheral edges of object C1. In some embodiments, the robotic system may calculate a confidence measure for edge features as a representation of certainty/likelihood that the edge feature corresponds with the peripheral edge of one of the flexible objects. In some embodiments, the robotic system can calculate the confidence measure based on a thickness/width, an orientation, a length, a shape/curvature, degree of continuity and/or other detected aspects of the edge features. In an example of generating the key points, the robotic system can process the pixels of the 2D image data using one or more circuits and/or algorithms, such as scale-invariant feature transform (SIFT) algorithms.

In some embodiments, the robotic system can generate the detection features to include estimates of sections or continuous surfaces bounded/defined by the edge features such as by identifying junctions between lines having different orientations. For example, the edge features in FIG. 4A can intersect with each other in locations where the objects overlap with each other thereby forming junctions. The robotic system can estimate the sections based on a set of the edge features and junctions. In other words, the robotic system can estimate each section as an area bounded/defined by the set of joined/connected edges. Additionally, the robotic system may estimate each section based on relative orientations of connected edges (e.g., parallel opposing edges, orthogonal connections, at predefined angles corresponding to templates representing the flexible object, or the like). For example, the robotic system can detect lines 406a-406d from the top view 400-1 image data and may further identify that the detected lines 406a-406d intersect with each other so that lines 406a and 406d are parallel to each other and lines 406b and 406c are orthogonal to the lines 406a and 406b so that the lines 406a-406d form a partial rectangular shape (e.g., a shape including three corners of a rectangular). The robotic system can therefore estimate that the detected lines 406a-406d are part of an object having a rectangular shape. However, it is understood that the shape, profile, or outline of the flexible object may be non-rectangular.

In some embodiments, the robotic system can determine the edge features based on the depth values. For example, the robotic system can identify exposed peripheral edges and corners based on the detected edges. The peripheral edges and corners can be identified based on depth values from the three-dimensional image data. When a difference between the depth values at different sides of a line is greater than a predetermined threshold difference, the robotic system can identify the line to be the edge feature.

The robotic system can calculate, such as based on the edge confidence measure, relative orientations of the connected edges, or the like, a confidence measure for each estimated section as a representation of certainty/likelihood that the estimated section is a continuous surface and/or a single one of the flexible object. For example, the robotic system can calculate a higher confidence measure when the estimated surface is surrounded by three dimensional edges in comparison to surfaces at least partially defined by two dimensional edges. Also, for example, the robotic system can calculate higher confidence measures when the edge junctions form angles that are closer to right angles for the flexible objects that have a rectangular shape.

At block 506, the robotic system can generate one or more detection result corresponding to the flexible objects located at the start location. In some embodiments, the robotic system can generate the one or more detection results based on comparing the detection features to templates for registered objects in the master data. For example, the robotic system can compare the detection features of the image data to corresponding features of the templates for the registered objects in in the master data. Also, in some embodiments, the robotic system can compare the dimensions of the estimated surfaces to the dimensions of the registered objects stored in the master data. In some embodiments, the robotic system can locate and scan visual identifiers (e.g., bar codes, QR codes, etc.) on the surface for determination. Based on the comparisons of the detection features and/or dimensions of the estimated surfaces, the robotic system can generate the detection result by positively identified detection features in the image data and/or determine a pose for the depicted object. The robotic system can calculate a confidence measure for each detection result based on the degree of match and/or the types of a match between the compared portions.

As an illustrative example of the comparison, the robotic system can compare the estimated rectangular shape formed by the lines 406a-406d in FIG. 4A to known object shapes (e.g., shapes of registered objects or objects expected to be at the start location) included in the master data. The robotic system can further compare the dimensions of the estimated rectangular shape to the dimensions of the known objects stored in the master data. When the robotic system is capable of matching the shape and dimensions or a portion thereof of the estimated rectangular shape in FIG. 4A to a known shape and dimensions of a known object in the master data, the robotic system can, with a certain confidence measure, estimate that the lines 406-a-406d are associated with the known object that is expected to be in the start location based on the master data.

In some embodiments, the robotic system can determine positively identified areas (e.g., the robotic system can categorize certain portions of the detection result as positively identified). A positively identified area can represent a portion of the detection result that has been verified to match one of the registered objects. For example, the robotic system can identify the portions of the detection result as the positively identified area when detection features in a corresponding portion of the image data matches the detection features of a template corresponding to the registered object and/or other physical attributes thereof (e.g., shape, a set of dimensions, and/or surface texture of the registered object). For image-based comparisons, the robotic system can calculate a score representative of a degree of match/difference between the received image and the template/texture image of registered objects. The robotic system can identify the portions as positively identified area when the corresponding score (e.g., a result of pixel-based comparison) is less than a difference threshold. In some embodiments, the positively identified area can be excluded from further occlusion processing, as the robotic system has high confidence that the positively identified area corresponds to the registered object.

In some embodiments, the robotic system can detect the flexible objects depicted in the received image based on analyzing a limited set of features or portions/subsections within the estimated surfaces. For example, the robotic system can positively identify the estimated surface as matching a template surface when at least a required amount of pixels for the template match or represented in the received image. The robotic system can determine the match when the corresponding pixels of the received image and the template image have values (e.g., color, brightness, position/location, etc.) that are within a threshold difference range. Additionally, the robotic system can compare the key points (e.g., corners), lines, or a combination thereof (e.g., shapes) to determine the match. The remaining portions of the estimated surface can correspond to portions that were not compared or that did not sufficiently match the template. Along with the object identification, the robotic system can identify the compared/matching portions within the received image data as the positively identified area.

When one or more of the detection results are generated from the image data, the robotic system can process each of the one or more detection results to identify contested portions of the one or more detection results. In some embodiments, the robotic system can process an instance of the one or more detection results individual as a target detection results.

At block 516, the robotic system can identify contested portions of a detection result. The contested portions can represent areas of the detection result having one or more uncertainty factors (e.g., insufficient confidence values, insufficient amount of matching pixels, overlapping detection footprints, and/or the like).

In one example, the contested portion can represent an uncertain region of the detection result. The uncertain region can be a portion of the detection result that include the detection features that are not or cannot be relied upon by the robotic system to generate the detection result (e.g., areas within the estimated surface that are outside of the positively identified areas). In another example, the contested portion can represent an occlusion region between the detection result and an adjacent object. The occlusion region can represent an overlap between an instance of the one or more flexible objects and a further instance of the one or more flexible objects. In general, when the robotic system generates one or more of the detection results, the robotic system can (e.g., iteratively) process each of the detection results as a target detection result belonging to or from the perspective of one of the intersecting objects (e.g., a target object). With reference to the over overlapping/overlapped object, the same portion can be referred to or processed as an adjacent detection result. In other words, the occlusion region is an overlap between (1) the target detection result corresponding to the instance of the one or more flexible objects (e.g., an object targeted by a current iteration) and (2) the adjacent detection result corresponding to the further instance of the one or more flexible objects.

The robotic system can determine an occlusion state for the occlusion region when the robotic system determines that the detection result includes the occlusion region. The occlusion state can describe which of the flexible objects is below the other flexible object in the occlusion region. The occlusion states can be one of an adjacent occlusion state, a target occlusion state, or an uncertain occlusion state. The adjacent occlusion state can indicate that the adjacent detection result is below the target detection result in the occlusion region. The target occlusion state can indicate that the target detection result is below the adjacent detection result in the occlusion region. The uncertain occlusion state can occur or represent when the overlap between the target detection result and the adjacent detection result it is uncertain. In other words, the uncertain occlusion state can represent when it cannot be confidently determined, by the robotic system, whether the target detection result is below the adjacent detection result or whether the adjacent detection result is below the target detection result. In some embodiments, the robotic system can indicate the uncertain occlusion state by indicating that the overlapped region is underneath for all intersecting objects. For example, for the occlusion region including overlap of object C3 and object B, the robotic system can indicate that (1) the overlapping portion of object C3 is underneath object B and (2) the overlapping portion of object B is underneath object C3. Accordingly, the robotic system can intentionally generate logically contradicting results to indicate the uncertain occlusion state. In response, the robotic system can ignore or exclude the occlusion region during motion planning (e.g., grip location determination portion thereof) for both objects B and C3.

The robotic system can determine the occlusion state for the occlusion region based on the detection features associated with the target detection result and/or the detection features associated with the adjacent detection result in the occlusion region. More specifically, the robotic system can analyze the detection features, including the edge features, the key points, the depth values, or a combination thereof, in the occlusion region to determine if the detection features belong to (e.g., corresponding to an exposed portion of) the target detection result or the adjacent detection result. In other words, the robotic system can determine the occlusion state according to which of the detection results include a greater percentage (based on a value or a correspondence score described further below) of the associated or corresponding detection features in the occlusion region.

In general, the robotic system can compare the features in the occlusion region to detection features of the target detection result and the adjacent detection result. The robotic system can determine the occlusion state as the adjacent occlusion state (e.g., an indication that the adjacent object is occluded by the targeted object meaning that the adjacent object is below the target object) when a greater percentage of the detection features correspond to the target detection result and is above a confidence threshold. The robotic system can determine the occlusion state as the target occlusion state (e.g., an indication that the target object is occluded by the adjacent object meaning the target object is below the adjacent object) when a greater percentage of the detection features correspond to the adjacent detection result and is above a confidence threshold. If analysis of the detection features is inconclusive (e.g. the percentage of detection features are not above a confidence threshold), then the robotic system can determine that the occlusion state is the uncertain occlusion state.

In some embodiments, the robotic system can determine the occlusion state as a combination of each of the detection features in the occlusion region. More specifically, the robotic system can calculate the correspondence score to determine whether the edge features, the key points, and/or the depth values correspond or belong to the target detection result or the adjacent detection result. In some embodiments, the correspondence score can be a composite score for each of the detection features while in other embodiments, the correspondence score can be calculated individually (e.g. an edge feature correspondence score, a key point correspondence score, and/or a depth value correspondence score) for each of the detection features and combine to calculate the correspondence score. In some embodiments, the robotic system can include weights for each of the detection features to increase or decrease the contribution of the corresponding detection feature in calculating the correspondence score.

Optionally, in some embodiments, as exemplified in FIG. 4A, the robotic system can identify the contested portions as illustrated in the top view 400-1 image data. In the optional embodiment, the contested portions can include areas having dimensions that are less than the smallest dimensions of registered objects. Since the edges corresponding to such contested portions correspond to multiple objects overlapping each other and include detected lines that arise from imprints and/or deformations on the object surfaces, the dimensions of the contested portions can be less than objects themselves. The contested portion 1 can correspond to a rectangularly shaped area having dimensions d1 and d2. The robotic system can identify, based on the comparison with the known objects in the master data, that such rectangularly shaped area having the dimensions d1 and d2 does not match with any of the known objects in the master data with a certain confidence measure (e.g., a confidence measure that is above a certain threshold confidence measure). The robotic system can, therefore, identify that the area as the contested portion 1. Similarly, the contested portion 2 defined by lines 408a and 408b corresponds to an area having an irregular shape (e.g., line 408b defines a shape of a rectangular while line 408a cuts off a portion of a top-left corner of the rectangular). The robotic system can identify, based on the comparison with the known objects in the master data, that such an irregularly shaped area does not match with any of the known objects (e.g., as represented by shape templates) in the master data with a certain confidence measure. The robotic system can, therefore, identify the area as the contested portion 2.

Optionally, in some embodiments, the robotic system can analyze surface continuity across one or more detected lines for the contested portions. For example, the robotic system can compare the depth value on opposing sides of the edge feature. As another example, the robotic system can analyze the continuity, parallel arrangements, and/or collinearity of lines (e.g., across other intersecting lines) under the contested portions to lines of adjacent objects to determine whether the lines under the contested portions can belong to an adjacent object. The determination can be performed, for example, by comparing the shape and dimensions of the object to known shapes and sizes of objects in the master data. For example, in FIG. 4A the robotic system can identify object C1 as having a partially rectangular shape based on the detected lines 406a-406d. The robotic system can further identify that line 408a is continuous/collinear with the line 406b. The robotic system can thereby estimate that the line 408a is in fact an edge belonging to object C1.

In some embodiments, the robotic system can also analyze the contested portions for surface features/textures, such as pictures or text on a surface of an object. The analyzing of the contested portions can include comparing the detected edges in a contested portion to known images, patterns, logos and/or pictures in the master data. In response to determining that the detected edges in the contested portion correspond to a known image, pattern, logo or/or picture, the robotic system can determine that the surface corresponding to the contested portion belongs to a single object. For example, the robotic system can compare the logo 404 (e.g., corresponding to the contested portion 3) to known logos and pictures in the master data. In response to determining that the logo 404 matches a known logo, the robotic system can determine that the area corresponding to the logo 404 in fact belongs to object C2. The robotic system can similarly identify visual patterns that extend across or into one or more contested portions to adjust the confidence that the corresponding portions are tied to one object.

Optionally, the robotic system can identify the rectangular enclosed areas as contested portions since the dimensions (e.g., d1 and d2) are less than the minimum object dimension listed in the master data. These uncertainties may result in confidence levels that fall below one or more predetermined thresholds, thereby causing the robotic system to generate the occlusion mask A1 to block the contested portions from processing. The robotic system can similarly process the overlapped portions on the bottom of object A to generate the occlusion masks A2 and B.

At block 517, the robotic system can generate detection mask information for the one or more detection results. The detection mask information describes different categories of regions within an estimated surface corresponding to a detection result, such as the positively identified areas and/or the contested portions of the detection result. The detection mask information can include positive identification information, occlusion region information, uncertain region information, or a combination thereof. The positive identification information describes the location or position and size/area for each of the positively identified areas in the detection results. The occlusion region information describes the location or position and size/area for each of the occlusion regions in the detection result. The uncertain region information describes the location or position and size/area for each of the uncertain regions in the detection result.

As an example of the detection mask information, Mask B can represent the occlusion region information for Object B of FIG. 4A for the occlusion region between Object B and Object C3. As another example, the area defined by the dashed lines of Object B can represent the positively identified information MASK B corresponding to the positively identified area.

The robotic system can generate the detection mask information as a guide or an input for deriving grippable regions (e.g., areas that are allowed to be contacted by the end-effector in gripping the corresponding object). For example, during motion planning (described below), the robotic system can identify and test grip locations that are (1) fully positioned within the positively identified areas, (2) partially within the positively identified areas and extending into uncertain regions, (3) completely outside of the occlusion region, or a combination thereof. In other words, the robotic system can use the positively identified areas along with surrounding uncertain regions, when necessary, as the grippable regions.

At block 512, the robotic system can derive a motion plan. The robotic system can derive motion plan according to a processing sequence associated with the detection mask information. For example, the robotic system can use the processing sequence that includes determining which of the flexible objects with corresponding detection results (also referred to as detected objects) are grippable objects based on the detection mask information; selecting a target object from the grippable objects; determining a grip location on the target object for an end-effector of the robotic arm based on the detection mask information and more specifically the positively identified area; calculating one or more trajectories for the robotic arm for transferring the target object from the start location to the destination location or a combination thereof.

In some embodiments, based on analyzing the positively identified areas, the robotic system can determine one or more grip locations. For example, the robotic system can determine the grip locations when the positively identified areas have dimensions that exceed the minimum grip requirements. The robotic system may determine the grip locations according to the derived sequence. For example, in FIG. 4A the robotic system can determine grip locations A and B for the positively identified areas that has dimensions that are greater than the minimum dimensions required to grip the target object with the end effector of the robotic arm and move (e.g., lift) the object. The robotic system can determine the grip location to be within the area on the surface of the target object corresponding to the positively identified area of the positive identification information. The robotic system can determine the grip location to avoid an area on the surface of the target object corresponding to the occlusion region of the occlusion information when the detection result for the detected object includes the occlusion region.

As an illustrative example, the robotic system can use the processing sequence that first determines whether one or more of the positively identified areas have a shape and/or a set of dimensions sufficient to encompass a footprint of the gripper. If such locations exist, the robotic system can process a set of grip poses within the positively identified areas according to other gripping requirements (e.g., locations/pose relative to CoM) to determine the grip location for the target object. If the positively identified areas for one object are each insufficient to surround the gripper footprint, the robotic system can then consider grip locations/poses that overlap and extend beyond the positively identified areas (e.g., into the uncertain regions). The robotic system can eliminate locations/poses that extend into or overlap the occlusion region. The robotic system can process the remaining locations/poses according to the other gripping requirements to determine the grip location for the target object.

In some embodiments, the robotic system can have different circuits or instruction groupings (e.g., module) for deriving the motion plan than for image analysis, such as generating the one or more detection results and/or the detection mask information. Accordingly, a first circuit/module can perform the image analysis (including, e.g., the detection process described above) and a second circuit/module can derive the motion plan based on the image analysis.

In some embodiments, the robotic system can derive the motion plan by placing a modeled footprint for the end-effector at the grip location and iteratively calculating approach trajectories the target object, depart trajectories from the start location after grasping the target object, transfer trajectories between the start location and the destination location, or other trajectories for transfer of the target object between the start location and the destination location. The robotic system can consider other movement directions or maneuvers when the trajectories overlap obstacles or are predicted to cause a collision or other errors. The robotic system can use the trajectories and/or corresponding commands, settings, etc. as the motion plan for transferring the target object from the start location to the destination location.

The robotic system can determine the grippable objects when the positively identified areas have dimensions that exceed the minimum grip requirements and when the robotic system can determine that the trajectories can be calculated to transfer the detected objects. In other words, if the robotic system is unable to calculate trajectories to transfer the detected object within a specified period of time and/or the positively identified areas for the detected object do not meet the minimum grip requirements, then the robotic system will not determine the detected object as the grippable object.

The robotic system can select the target object from the grippable objects. In some embodiments, the robotic system can select the target object for the grippable object that does not include the occlusion regions. In other embodiments, the robotic system can select the target object as the grippable object for which trajectory calculations are completed first. In yet further embodiments, the robotic system can select the target object as the grippable object with the fasted transfer time.

In some embodiments, the robotic system can be configured to derive the motion plan for lifting the target object first and then laterally transferring the object. In some embodiments, the robotic system can derive the motion plan for sliding or laterally displacing the target object, such as to clear any object overlaps, before transferring the target object and/or re-obtaining and processing image data.

At block 514, the robotic system can implement the derived motion plan(s). The robotic system (via, e.g., the processor and the communication device) can implement the motion plan(s) by communicating the path and/or the corresponding commands, settings, etc. to the robotic arm assembly. The robotic arm assembly can execute the motion plan(s) to transfer the target object(s) from the start location to the destination location as indicated by the motion plan(s).

As illustrated by the feedback loop, the robotic system can obtain a new set of images after implementing the motion plan(s) and repeat the processes described above for blocks 502-512. The robotic system can repeat the processes until the source container is empty, until all targeted objects have been transferred, or when no viable solutions remain (e.g., error condition where the detected edges do not form at least one viable surface portion).

Though the process flow presented in FIG. 5 has a certain order, it is understood that certain actions described with respect to the blocks 504 through 528 can be performed in an alternative sequence or order.

### EXAMPLES

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.
1. An example method of operating a robotic system, the method comprising:
generating detection features based on image data representative of one or more flexible objects at a start location;
generating a detection result corresponding to the one or more flexible objects based on the detection features;
determining whether the detection result indicates an occlusion region, wherein the occlusion region represents an overlap between an instance of the one or more flexible objects and a further instance of the one or more flexible objects;
generating detection mask information for the detection result, wherein the detection mask information includes positive identification information; and
deriving a motion plan for the target object, wherein the motion plan includes:

a target object selected from the one or more flexible objects based on the detection mask information

a grip location, on the target object, for an end-effector of a robotic arm based on the detection mask information, and

one or more trajectories for the robotic arm for transferring the target object from the start location to a destination location.
2. The example method 1 or one or more portions thereof, further comprising determining the grip location within an area on a surface of the target object corresponding to the positive identification information.
3. Any one or more of example methods 1 and 2, and/or a combination of one or more portions thereof, further comprising determining the grip location to avoid an area on a surface of the target object corresponding to occlusion information when the detection result includes the occlusion region.
4. Any one or more of example methods 1-3 and/or a combination of one or more portions thereof, wherein the occlusion region is an overlap between a target detection result corresponding to the instance of the one or more flexible objects and an adjacent detection result corresponding to the further instance of the one or more flexible objects.
5. Any one or more of example methods 1-4 and/or a combination of one or more portions thereof, further comprising determining an occlusion state for the occlusion region, wherein the occlusion state is one of:
(1) an adjacent occlusion state representing the adjacent detection result below the target detection result in the occlusion region,
(2) a target occlusion state representing the target detection result below the adjacent detection result in the occlusion region, or
(3) an uncertain occlusion state when the overlap between the target detection result and the adjacent detection result it is uncertain.
6. Any one or more of example methods 1-5 and/or a combination of one or more portions thereof, further comprising determining an occlusion state for the occlusion region based on the detection features corresponding with the target detection result and/or the detection features corresponding with the adjacent detection result in the occlusion region.
7. Any one or more of example methods 1-6 and/or a combination of one or more portions thereof, wherein:
the detection features include edge features, key points, depth values, or a combination thereof;
further comprising:
generating the positive identification information for a region in the image data when the edge information, key point information, height measure information, or a combination thereof; and
generating the detection result includes generating the detection result based on the edge information, key point information, height measure information, or a combination thereof.
8. An example method of operating a robotic system, the method comprising:
obtaining image data representative of at least a first object and a second object at a start location;
based on the image data, determining that the first and second objects overlap each other;
identifying an overlapping region based on the image data in response to the determination, wherein the overlapping region represents an area where at least a portion of the first object overlaps at least a portion of the second object; and
categorizing the overlapping region based on one or more depicted characteristics for motion planning.
9. Any one or more of example methods 1-8 and/or a combination of one or more portions thereof, further comprising generating first and second detection results based on the image data wherein:
the first and second detection results respectively identify the first and second objects depicted in the image data; and
generating the first and second detection results includes:

using master data that describes physical attributes of registered objects, identifying shapes of the first and second objects corresponding to the first and second detection results;

determining that the first and second objects overlap includes comparing the shapes of the first and second objects to the image data; and

identifying the overlapping region corresponding to a portion of the image data that corresponds to the shapes of both the first and second objects.
10. Any one or more of example methods 1-9 and/or a combination of one or more portions thereof, further comprising generating a first detection result based on the image data, wherein the first detection result identifies the first object and a location thereof, and wherein generating the first detection result further includes:
according to a master data that describes physical attributes of registered objects, identifying at least a first shape corresponding to the first detection result; and
determining that the first and second objects overlap based on identifying an unexpected line or edge in a portion of the image data corresponding to the first object based on a comparison of the portion to an expected surface characteristic of the first object in the master data, wherein the unexpected line or edge corresponds to (1) an edge of the second object that extends over the first object or (2) a surface deformation formed on the first object based on the first object partially overlapping the second object when the first object is identified as a flexible object according to the master data.
11. Any one or more of example methods 1-10 and/or a combination of one or more portions thereof, wherein generating the first detection result further includes identifying whether (1) the first object is above/overlapping the second object in the overlapping region, (2) the first object is below or overlaid by the second object in the overlapping region, or (3) there is insufficient evidence to conclude a vertical positioning of the first object relative to the second object.
12. Any one or more of example methods 1-11 and/or a combination of one or more portions thereof, wherein identifying that there is insufficient evidence includes:
identifying that the first object is under the second object in the overlapping region; and
generating a second detection result based on the image data, wherein the second detection result identifies the second object and a location thereof and further indicates that the second object is under the first object in the overlapping region.
13. Any one or more of example methods 1-12 and/or a combination of one or more portions thereof, wherein:
generating the first detection result further includes identifying one or more portions of the image data corresponding to the first object as:

(1) a positively identified area that matched a corresponding portion of an expected surface image in the master data for the first object,

(2) the overlapping region, or

(3) an uncertain region; and
further comprising:
deriving a grip location for grasping the first object with a gripper in transferring the first object to a destination, wherein the grip location is derived based on (1) maximizing an overlap between a gripper footprint and the positively identified area and (2) keeping the gripper footprint outside of the overlapping region.
14. Any robotic system comprising:
at least one processor; and
at least one memory including processor instructions that, when executed, causes the at least one processor to perform any one or more of example methods 1-13 and/or a combination of one or more portions thereof.
15. non-transitory computer readable medium including processor instructions that, when executed by one or more processors, causes the one or more processors to perform any one or more of example methods 1-13 and/or a combination of one or more portions thereof.

### Conclusion

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

These and other changes can be made to the disclosed technology in light of the above Detailed Description. While the Detailed Description describes certain examples of the disclosed technology as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

What is claimed is:

1. A method of operating a robotic system, the method comprising:
generating detection features based on image data representative of one or more flexible objects at a start location;
generating a detection result corresponding to the one or more flexible objects based on the detection features;
determining whether the detection result indicates an occlusion region, wherein the occlusion region represents an overlap between an instance of the one or more flexible objects and a further instance of the one or more flexible objects;
generating detection mask information for the detection result, wherein the detection mask information includes positive identification information; and
deriving a motion plan for the target object, wherein the motion plan includes:
a target object selected from the one or more flexible objects based on the detection mask information
a grip location, on the target object, for an end-effector of a robotic arm based on the detection mask information, and
one or more trajectories for the robotic arm for transferring the target object from the start location to a destination location.

2. The method of claim 1, further comprising determining the grip location within an area on a surface of the target object corresponding to the positive identification information.

3. The method of claim 1 further comprising determining the grip location to avoid an area on a surface of the target object corresponding to occlusion information when the detection result includes the occlusion region.

4. The method of claim 1, wherein the occlusion region is an overlap between a target detection result corresponding to the instance of the one or more flexible objects and an adjacent detection result corresponding to the further instance of the one or more flexible objects.

5. The method of claim 4, further comprising determining an occlusion state for the occlusion region, wherein the occlusion state is one of:
(1) an adjacent occlusion state representing the adjacent detection result below the target detection result in the occlusion region,
(2) a target occlusion state representing the target detection result below the adjacent detection result in the occlusion region, or
(3) an uncertain occlusion state when the overlap between the target detection result and the adjacent detection result it is uncertain.

6. The method of claim 4, further comprising determining an occlusion state for the occlusion region based on the detection features corresponding with the target detection result and/or the detection features corresponding with the adjacent detection result in the occlusion region.

7. The method of claim 1, wherein:
the detection features include edge features, key points, depth values, or a combination thereof;
further comprising:
generating the positive identification information for a region in the image data when the edge information, key point information, height measure information, or a combination thereof; and
generating the detection result includes generating the detection result based on the edge information, key point information, height measure information, or a combination thereof.

8. A robotic system comprising:
at least one processor; and
at least one memory including processor instructions that, when executed, causes the at least one processor to:
generate detection features based on image data representative of one or more flexible objects at a start location;
generate a detection result corresponding to the one or more flexible objects based on the detection features;
determine whether the detection result indicates an occlusion region, wherein the occlusion region represents an overlap between an instance of the one or more flexible objects and a further instance of the one or more flexible objects;
generate detection mask information for the detection result, wherein the detection mask information includes positive identification information; and
derive a motion plan for the target object, wherein the motion plan includes:
a target object selected from the one or more flexible objects based on the detection mask information
a grip location, on the target object, for an end-effector of a robotic arm based on the detection mask information, and
one or more trajectories for the robotic arm for transferring the target object from the start location to a destination location.

9. The system of claim 8, wherein the processor instructions further cause the at least one processor to determine the grip location within an area on a surface of the target object corresponding to the positive identification information.

10. The system of claim 8, wherein the processor instructions further cause the at least one processor to determine the grip location to avoid an area on a surface of the target object corresponding to occlusion information when the detection result includes the occlusion region.

11. The system of claim 8, wherein the occlusion region is an overlap between a target detection result corresponding to the instance of the one or more flexible objects and an adjacent detection result corresponding to the further instance of the one or more flexible objects.

12. The system of claim 11, wherein the processor instructions further cause the at least one processor to determine an occlusion state for the occlusion region, wherein the occlusion state is one of:
(1) an adjacent occlusion state representing the adjacent detection result below the target detection result in the occlusion region,
(2) a target occlusion state representing the target detection result below the adjacent detection result in the occlusion region, or
(3) an uncertain occlusion state when the overlap between the target detection result and the adjacent detection result it is uncertain.

13. The system of claim 11, wherein the processor instructions further cause the at least one processor to determine an occlusion state for the occlusion region based on the detection features corresponding with the target detection result and/or the detection features corresponding with the adjacent detection result in the occlusion region.

14. The system of claim 8, wherein:
the detection features include edge features, key points, depth values, or a combination thereof; and
the processor instructions further cause the at least one processor to:
generate the positive identification information for a region in the image data when the edge information, key point information, height measure information, or a combination thereof; and
generate the detection result based on the edge information, key point information, height measure information, or a combination thereof.

15. A non-transitory computer readable medium including processor instructions that, when executed by one or more processors, causes the one or more processors to:
generate detection features based on image data representative of one or more flexible objects at a start location;
generate a detection result corresponding to the one or more flexible objects based on the detection features;
determine whether the detection result indicates an occlusion region, wherein the occlusion region represents an overlap between an instance of the one or more flexible objects and a further instance of the one or more flexible objects;
generate detection mask information for the detection result, wherein the detection mask information includes positive identification information; and
derive a motion plan for the target object, wherein the motion plan includes:
a target object selected from the one or more flexible objects based on the detection mask information
a grip location, on the target object, for an end-effector of a robotic arm based on the detection mask information, and
one or more trajectories for the robotic arm for transferring the target object from the start location to a destination location.

16. The non-transitory computer readable medium of claim 15, wherein the processor instructions further cause the one or more processors to determine the grip location within an area on a surface of the target object corresponding to the positive identification information.

17. The non-transitory computer readable medium of claim 15, wherein the occlusion region is an overlap between a target detection result corresponding to the instance of the one or more flexible objects and an adjacent detection result corresponding to the further instance of the one or more flexible objects.

18. The non-transitory computer readable medium of claim 17, wherein processor instructions further cause the one or more processors to determine an occlusion state for the occlusion region, wherein the occlusion state is one of:
(1) an adjacent occlusion state representing the adjacent detection result below the target detection result in the occlusion region,
(2) a target occlusion state representing the target detection result below the adjacent detection result in the occlusion region, or
(3) an uncertain occlusion state when the overlap between the target detection result and the adjacent detection result it is uncertain.

19. The non-transitory computer readable medium of claim 17, wherein processor instructions further cause the one or more processors to determine an occlusion state for the occlusion region based on the detection features corresponding with the target detection result and/or the detection features corresponding with the adjacent detection result in the occlusion region.

20. The non-transitory computer readable medium of claim 15, wherein:
the detection features include edge features, key points, depth values, or a combination thereof; and
the processor instructions further cause the one or more processors to:
generate the positive identification information for a region in the image data when the edge information, key point information, height measure information, or a combination thereof; and
generate the detection result based on the edge information, key point information, height measure information, or a combination thereof.
